(19) United States
(12) Patent Application Publication
(10) Pub. No.: US 2016/0292408 A1
(43) Pub. Date: Oct. 6, 2016

(54) CONTINUOUSLY AUTHENTICATING A USER OF VOICE RECOGNITION SERVICES

(71) Applicant: CA, INC., New York, NY (US)

(72) Inventors: LIXIN ZHANG, Thornhill (CA); PREETDEEP KUMAR, Hyderabad (IN); RAMAPRAKASH GANESAN, Hyderabad (IN); PREETI ARORA, Hyderabad (IN); JUDITH KRUNTORAD, Framingham, MA (US); STEVEN GREENSPAN, Ewing, NJ (US)

(73) Assignee: CA, INC., New York, NY (US)

(21) Appl. No.: 14/674,995

(22) Filed: Mar. 31, 2015

(51) Int. Cl. G06F 21/32; G10L 15/24; G10L 17/20; G10L 17/04; G10L 17/08

(52) U.S. Cl. CPC G06F 21/32; G10L 17/04; G10L 17/08; G10L 17/20; G10L 15/24

(57) ABSTRACT

A method for continuously authenticating a user of voice recognition services is described. According to the method a user is initially authenticated, with a user interface for a computer system that accepts vocal input, by comparing vocal input to a pre-recorded file corresponding to an approved user. The input from a current user is compared to an approved user profile corresponding to the approved user. A risk factor is determined based on a deviation of current user input to the user interface from the approved user profile. The current user is selectively re-authenticated based on the risk factor.

### BACKGROUND

A user of voice recognition services may to input spoken comments to an electronic system may need to be authenticated to begin use of the service, i.e., before the system will accept voice or other commands. Once authenticated, the user may then provide voice commands to the service, causing the service to perform the commands on behalf of the user. The use of voice commands may allow a user to have commands executed without entering the commands on a keyboard, selecting an option with a mouse, or using similar input devices.

### BRIEF SUMMARY

According to one aspect of the present disclosure, a method is implemented by a voice authentication system to provide continuous authentication of a user of voice recognition services. According to the method, with a user interface for a computer system that accepts vocal input, initially authenticating a user by comparing vocal input to a pre-recorded file corresponding to an approved user. The method includes comparing input from a current user to an approved user profile corresponding to the approved user. The method includes determining a risk factor based on a deviation of current user input to the user interface from the approved user profile. The method includes selectively re-authenticating the current user based on the risk factor.

According to one aspect of the present disclosure, a continuous user voice authentication system that authenticates a user of a voice recognition system, the system includes a processor with memory communicatively connected to the processor, an audio input device, and a voice authentication system. The voice authentication system includes an authenticating module, a comparing module, a location identifying module, a determining module, and a re-authentication module. The authenticating module initially authenticates, using the audio input device, a user by comparing vocal input to a pre-recorded file corresponding to an approved user. The comparing module compares input from a current user to an approved user profile corresponding to the approved user. The location identifying module identifies a user location, the user location being the location of the current user. The determining module determines a risk factor based on a deviation of current user input to the user interface from the approved user profile. The re-authenticating module selectively re-authenticates the current user based on the risk factor.

According to one aspect of the present disclosure, a system for continuously authenticating a user of voice recognition services includes a computer program product, which includes a non-transitory computer readable storage medium, the computer readable storage medium having computer readable program code embodied therewith. The computer readable program code has program code to initially authenticate, with a user interface for a computer system that accepts vocal input, a user by comparing vocal input to a pre-recorded file corresponding to an approved user. The computer readable program code has program code to compare input from a current user to an approved user profile corresponding to the approved user. The computer readable program code has program code to determine a risk factor based on a deviation of current user input to the user interface from the approved user profile. The computer readable program code has program code to selectively re-authenticate the current user based on the risk factor.

### BRIEF DESCRIPTION OF THE DRAWINGS

Aspects of the present disclosure are illustrated by way of example and are not limited by the accompanying figures, with like references indicating like elements.

FIG. 1 illustrates an example of a continuous voice authentication system, according to one example of the principles described herein.

FIG. 2 illustrates an example of a continuous voice authentication system, according to one example of the principles described herein.

FIG. 3 illustrates a system for continuously authenticating a user of voice recognition services, according to the principles described herein.

FIG. 4 illustrates a system for continuously authenticating a user of voice recognition services, according to the principles described herein.

FIG. 5 illustrates a flowchart of a method implemented by a continuous voice authentication system, according to one example of principles described herein.

FIG. 6 illustrates a flowchart of a method implemented by a continuous voice authentication system, according to one example of principles described herein.

FIG. 7 illustrates a diagram of a system for continuously authenticating a user of voice recognition services, according to one example of the principles described herein.

Throughout the drawings, identical reference numbers designate similar, but not necessarily identical, elements.

### DETAILED DESCRIPTION

The present specification describes a method and system for continuously authenticating a user of voice recognition services, such that if the user is impersonated the system detects the imposter.

The subject matter described herein may be a system, a method, and/or a computer program product. The computer program product may include a computer readable storage medium (or media) having computer readable program instructions thereon for causing a processor to carry out aspects of the subject matter described herein.

As will be appreciated by one skilled in the art, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented as entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but is not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but is not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment, or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that, when executed, can direct a computer, other programmable data processing apparatus, or other devices to function in a particular manner, such that the instructions, when stored in the computer readable medium, produce an article of manufacture including instructions which, when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

Voice recognition services allow a user to perform commands without using buttons, keyboards, pointer devices, or other devices to provide input to a computer. Consequently, a voice recognition device permits a user to use the device without frequent use of hands. Voice recognition devices have a broad set of application scenarios, such as a hands-free telephone in a car. An imposter user may attempt to gain control of a device by recording a spoken authentication sequence made by an authorized user and replaying the sequence to the voice recognition service at a later time. Additionally, where an authorized user has logged into a system with voice recognition functionality and has left the interface machine still logged in, an imposter user may take control over a device that has granted access to an authenticated user, and continue using the device for unauthorized purposes. Additionally, it may be possible for an imposter user to electronically or otherwise mimic the voice an approved user to gain access to the voice recognition system. Users of voice recognition systems desire systems to maintain security of the voice recognition system, while allowing ease of use of the voice recognition system. A system for continuously or at least periodically re-authenticating a user of a voice recognition service allows a user the benefit of a voice recognition system, while providing security that the system will not grant access to an imposter user

According to the principles described herein, a system for continuously authenticating a user of voice recognition services prevents an imposter user of a voice recognition service from gaining access to the voice recognition system by impersonating an authentic user. The continuous authentication system monitors the voice of a user for changes. The system may monitor for changes in the behaviors of a user. When a change indicates that the actual user may be a different person, the system will re-authenticate the user. Re-authenticating the user protects an approved user from imposter users gaining access to the system.

As used in the present specification and appended claims, the term “user” means a person using the system. A user may be an approved individual who is approved and has permission to perform tasks on the system. A user may also be an individual who is not approved, and does not have permission to perform tasks on the system, but is attempting to gain access to the system. Such a user may be referred to as an imposter user to distinguish the lack of authorization to access the system.

As used in the present specification and appended claims, the term “voice” means sounds produced by humans when speaking or expressing thoughts. A voice includes sounds and words emanating from the user to direct the system which comprise the voice of the user. The voice may be recorded into a computer file for later processing by the system.

As used in the present specification and appended claims, the term “voice sample” means a segment of the voice of a user over a period of time, the segment being capable of being processed by a computing device. A voice sample may contain a queue of segments where one segment is removed when a different segment is added. A voice sample allows a system to work with a portion of the user voice.

As used in the present specification and appended claims, the term “voice recognition” refers to the process of comparing a user voice, or a user voice sample, with a previous voice sample to identify that the user voice and the previous voice sample were generated by the same person. The voice recognition process by a device authenticates that a user voice matches a known voice sample to identify the user. Voice recognition may compare attributes of a user voice or a user voice sample with attributes of the previous voice sample to determine that it is the same person speaking.

As used in the present specification and appended claims, the term “current user” refers to a user that is currently using the voice authentication system. A current user may be a different user than a user that has authenticated or re-authenticated and may be an imposter user.

As used in the present specification and appended claims, the term “location” refers to a place where a user is, or where a user is when the user is speaking and issuing spoken commands. A user location may be determined by the location of a computing device that the user is using. A location may be used to determine attributes of the location. For example, a location that is in a public shopping center may be determined to be public, while a location in a data center may be determined to be secure.

As used in the present specification and appended claims, the term “behavior” refers to patterns of activity engaged in by a user. A change in behavior indicates a change in confidence that a user is intended to have access. A behavior may include physical movements the user engages in. For example, a user may visit a location at a certain time each day. A behavior may be a command set that a user customarily issues.

As used in the present specification and appended claims, the term “nonverbal” refers to activity that does not include the voice of a user. Nonverbal activity by a user includes physical movement of a user, or entering information on a computing device using a keyboard or similar input device.

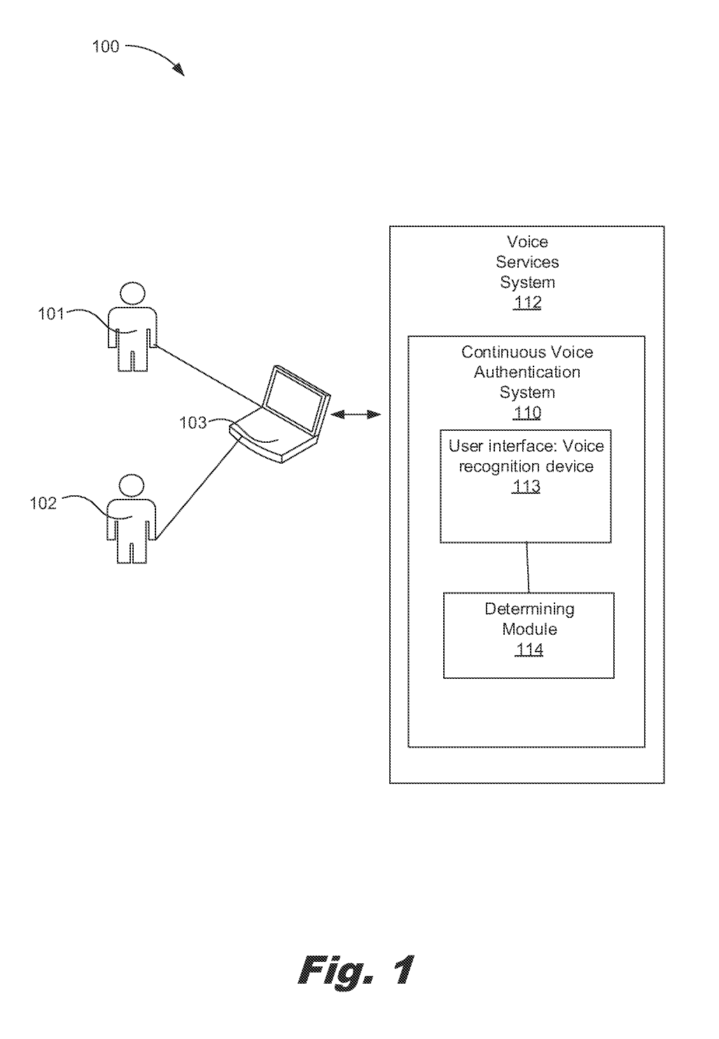

Referring now to the figures, FIG. 1 illustrates an example of a voice authentication system, according to one example of the principles described herein. A voice authentication system includes a voice services system and a continuous voice authentication system. The continuous authentication system includes a determining module, the determining module determines whether a user voice belongs to an imposter user. The continuous authentication system re-authenticates the user voice to ensure that the user is an approved user.

As illustrated in FIG. 1, the system (100) includes a voice services system (112) that is able to receive spoken user commands to control at least some operations of the system (112). The voice services system (112) receives a voice sample from a current user using a voice recognition device (103), interprets the voice sample, and executes the voice commands. As defined above, the user currently using the voice recognition device (103) is a current user. As illustrated, an approved user (101) may be the current user of a voice recognition device (103). An imposter user (102) may be the current user of the voice recognition device (103). As will be described below, an imposter user (102) may attempt to take the place of the approved user (101) to become the current user of the voice recognition device (103) and gain control of the voice services system (112). The voice services system (112) includes a voice recognition system (113) and a continuous voice authentication system (110) to detect the imposter user (102) who is attempting to take the place of the approved user (101) as the current user.

The system (100) may include a number of approved users (101). The approved users (101) may interact directly with the voice services system (112). The approved users (101) that are using a voice recognition device (103) are current users. The voice services system (112) may reside on a device used by a current user. A voice recognition device (103) used by a current user to interact with the voice services system (112) may include a personal computer, a laptop, a tablet, a cell phone, or another device capable of hosting the voice services system.

The system (100) may also include a number of imposter users (102). The imposter users (102) may attempt to gain access to the voice services system (112) by absconding with the security permission of an approved user (101). An imposter user (102) may use an audio recording of the individual approved user to pass through user authentication to obtain access to the voice services system (112). An imposter user (102) may abscond with a voice recognition device (103) used by an approved user (101), the voice recognition device (103) already being enabled to use the voice services system (112). The imposter user (102) may then use the authenticated voice recognition device (103) to continue to run commands on the voice services system (112). The voice services system (112) may use a continuous voice authentication system (110) to detect the imposter user (102), and to deny the imposter user (102) access to the voice services system (112).

As illustrated in FIG. 1, the system (100) includes a voice services system (112). The voice services system (112) supplies voice recognition and command services for a current user. The current user may speak a command to be executed by the voice services system (112). The command may be recorded and transmitted to a voice services system (112). The voice services system (112) may reside on a mobile device associated with the current user. The command may execute on the voice services system to perform tasks for the current user. The voice command may operate the voice service system (112) by obtaining information and executing commands for the current user. The voice services system (112) may receive a number of commands from a number of current users.

The voice services system (112) receives voice commands from a current user. The voice services system (112) continuously authenticates the user through the continuous voice authentication system (110). When an imposter user (102) gains control of the device or account used by the approved user (101), the imposter user (102) becomes a current user. The continuous voice authentication system (110) detects the change in user and begins re-authentication of the current user. The continuous voice authentication system (110) will re-authenticate the current user. An imposter user (102) will not be successful at re-authentication, and preventative measures may be taken to prevent nefarious access to the voice services system (112) by an imposter user (102). An imposter user (102) that gains access to the voice services system (112) by recording an approved user will exhaust the recording or deviate from the recording. The continuous voice authentication system (110) will detect the deviation and will re-authenticate the imposter user (102). The imposter user (102) will not be able to successfully re-authenticate, and preventative measures will be taken.

The continuous voice authentication system (110) samples the vocal input from a current user. The continuous voice authentication system (110) identifies, based on the samples of the vocal input, a user vocal pattern. The continuous voice authentication system (110) determines, using a determination module (114), a risk factor based on a deviation of current user input to the user interface from the approved user profile. The determination module (114) may consider factors such as voice frequency, sound pronunciation, word usage, grammar usage, vocabulary usage, and sound patterns. The continuous voice authentication system (110) re-authenticates the current user when the risk factors indicate the current user is an imposter user (102).

The voice recognition device (103), the continuous voice authentication system (110), and the voice services system (112) may reside on separate computers. The voice recognition device (103), the continuous voice authentication system (110), and the voice services system (112) may communicate over a network. The users may use a single voice recognition device (103) that has integrated a user device, a continuous voice authentication system (110), and a voice services system (114).

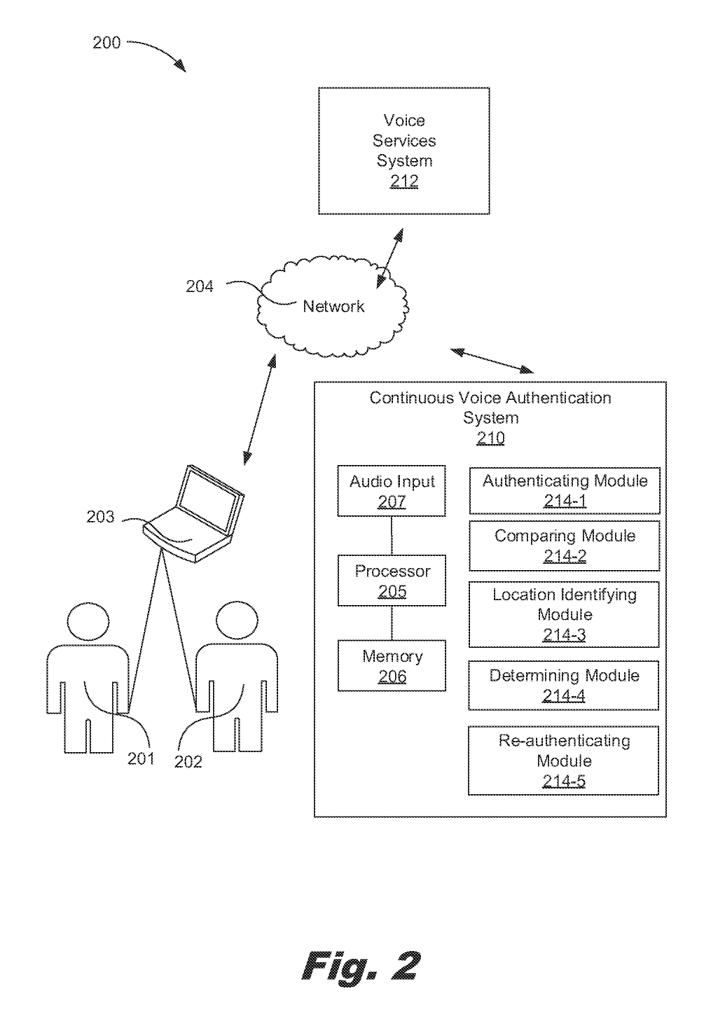

FIG. 2 is a diagram of a system (200) for continuously authenticating a user of voice services system (212), according to one example of the principles described herein. As will be described below, a voice services system (212) receives voice commands from a user (201, 202). A voice services system (212) is in communication with a continuous voice authentication system (210) to authenticate the user (201, 202). The continuous voice authentication system (210) includes an authenticating module (214-1), a comparing module (214-2), a determining module (214-4), and a re-authenticating module (214-5). The authenticating module (214-1) initially authenticates, using the audio input device, a user (201, 202) by comparing vocal input to a pre-recorded file corresponding to an approved user. The comparing module (214-2) compares input from a current user to an approved user profile corresponding to the approved user. The location identifying module (214-3) identifies a user location. The user location is the location of the current user. The determining module (214-4) determines a risk factor based on a deviation of current user input to the user interface from the approved user profile. The re-authenticating module (214-5), to selectively re-authenticate the current user based on the risk factor.

As illustrated in FIG. 2, the system (200) includes a voice services system (212). The voice services system (212) may be a computing system that processes voice files into computer commands. The voice services system (212) receives, from a current user, a voice sample. A current user is either an approved user (201) or an imposter user (202) using the voice recognition device (203). As illustrated, the voice services system (212) communicates with a continuous voice authentication system (210) over a network (206). The continuous voice authentication system (210) is used to continuously authenticate the current user to ensure that the actual user does not change, or that circumstances do not indicate that the current user may be an imposter user (202).

The system (200) includes a continuous voice authentication system (210). The continuous voice authentication system (210) includes a processor (205) communicatively connected to memory (206). The continuous voice authentication system (210) includes an audio input (207), the audio input (207) acquiring voice audio information that can be used to authenticate a user. The modules (214) refer to computer program code which, when executed by the processor (205), performs a designated function. The modules (214) may be implemented as computer program code which, when executed by the processor (205), performs a designated function. The modules (214) may be implemented as a combination of hardware and program instructions to perform a designated function. The program code causes the processor (214) to execute the designated function of the modules.

As illustrated, the continuous voice authentication system (210) includes a number of modules (214). As illustrated, the continuous voice authentication system (210) includes an authenticating module (214-1), a comparing module (214-2), a location identifying module (214-3), a determining module (214-4), and a re-authenticating module. As will be described below, the voice services system (212) invokes the continuous voice authentication system (210) to monitor that a current user has not become an imposter user (202).

The continuous voice authentication system (210) includes an authentication module (214-1). The authentication module (214-1) initially authenticates, using the audio input device, a user by comparing vocal input to a pre-recorded file corresponding to an approved user. The comparing may provide varying degrees of confidence that the current user attempting the authentication is an approved user. For example, the vocal input may include information, such as a password, a passphrase, a number of challenge questions, a time-based token, a verbal phrase or challenge, biometric data, or similar information. A number of items in the set of authentication parameters may be used. The authentication module (214-1) may use a number of items from the set of authentication parameters. The authentication module (214-1) may use a different number of items from the information.

The continuous voice authentication system (210) includes a comparing module (214-2) to compare input from a current user to an approved user profile corresponding to the approved user. The comparing module (214-2) may compare a voice sample with a saved voice print of an approved user. The comparing module (214-2) may analyze the voice sample for voice tone recognition. The comparing module (214-2) may identify characteristics of the voice sample, such as voice tone, voice tone pattern, word usage pattern, sound usage patterns, verbal accents, or voice command usage patterns. The comparing module (214-2) may identify a number of characteristics of the voice sample. The identifying module (214-2) may identify changes in the user vocal pattern.

The continuous voice authenticating system (210) includes a location identifying module (214-3) to identify a user location. The user location is the location of the current user. They location may identify when a user is in a public location or a private location. A user in a public location may have an increased risk factor of being an imposter, due to the increased probability of another user accessing a device (203). A user in a private location, such as an office, may have the risk factor of being an imposter decreased, due to the decreased chance that another user has obtained access to the device (203). The physical location may be determined by tracing the network address of the device (203). The physical location may be determined using a global positioning system associated with the device (203).

The continuous voice authentication system (210) includes a determining module (214-4) to determine a risk factor based on a deviation of current user input to the user interface from the current user input to the user interface from the approved user profile. The risk factor provides an indication of the likelihood that the user accessing the voice services system (212) is an imposter. Changes that have been identified in the user vocal pattern may be determined, by the determining module (214-4), to indicate an increased risk that the current user is an imposter user (202). A risk factor may be increased as a result of minor variations in a number of voice characteristics. A risk factor may be increased as a result of a significant variation in a single voice characteristic.

The continuous voice authentication system (210) includes a re-authenticating module (214-5) to selectively re-authenticating the current user based on the risk factor. The re-authenticating module (214-5) may use increased criteria to re-authenticate a user that has an increased risk factor. The re-authenticating module (214-5) may decrease criteria to re-authenticate a user that has a lower risk factor. The re-authenticating module (214-5) may determine that the risk factor provides sufficient re-authentication, or that the continued monitoring of the voice of the current user is adequate re-authentication.

The re-authentication module (214-5) determines the amount of re-authentication a current user is to provide. The re-authenticating module (214-5) may use both verbal and nonverbal characteristics measured to select a re-authentication protocol for a user. The re-authenticating module (214-5) may use a number of re-authentication procedures to re-authenticate a current user. In one example, a user in a public forum is prompted to provide non-verbal information to re-authenticate. This allows the user to prevent others from hearing the verbal information during the re-authentication process. In another example, a user that is in a secure setting may be re-authenticated using voice commands, as it is less likely that someone could overhear the command.

FIG. 2 will now be described. A user is then authenticated by the authentication module (214-1), using a set of authentication parameters to create an approved user (201). The authentication module (214-1) may use nonverbal authentication, such as passwords, passcodes, or biometric data. The authentication module (214-1) may use verbal authentication, such as challenge questions and voice characteristic measurements, to authenticate a user. The current user is successfully authenticated and allowed to user the voice services system.

The comparing module (214-2) compares voice characteristics of the current user. When an imposter user (202) usurps control of a device from the approved user (201) to become the current user, the comparing module (214-2) will compare voice samples from the imposter user (202), the imposter user (202) attempting to act as the approved user (201). The voice samples will then be from the imposter user (202). The comparing module (214-2) compares non-verbal activity of an approved user (201) to the non-verbal activity of an imposter user (202). An imposter user (202) will deviate from the voice characteristics of the approved user (201).

The location identifying module (214-3) identifies the location of the current user. The current user is identified to be in a location where the approved user has not previously been.

The determining module (214-4) determines a risk factor based on the vocal sample. An imposter user (203) does not possess the exact tones and characteristics of the approved user (201), and therefore when the current user is the imposter user (203), the current user will receive a higher risk factor. The user is determined to have an increased risk factor based on the combination of the deviation from the voice characteristics and the identified location being a location where the approved user (201) has not previously been.

The re-authenticating module (214-5), upon receiving the elevated risk factor, will re-authenticate the imposter user (202). The increased risk factor, based on the combination of the deviation from the voice characteristics and the identified location being a location the approved user (201) has not been, cause the re-authenticating module (214-5) to user a password, biometric data, and a new voice sample to re-authenticate the user.

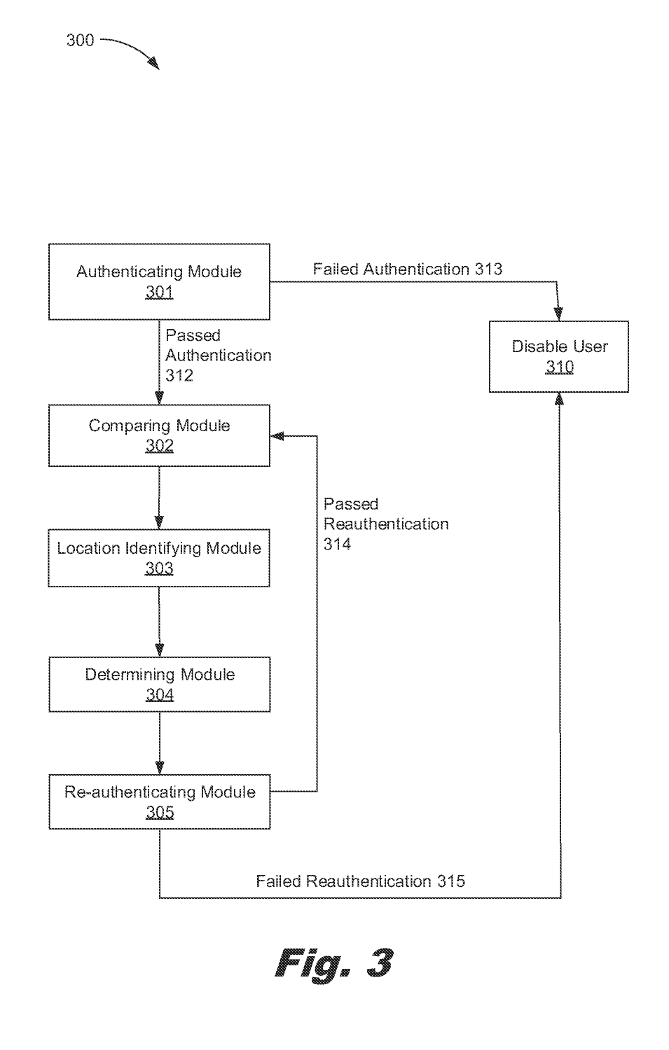

FIG. 3 illustrates a system (300) for continuously authenticating a user of voice recognition services, according to the principles described herein. In this example, the authentication module (301) uses a set authentication parameters to authenticate a current user and identify the current user as an approved user (FIG. 1, 101). When a user passes authentication (312), the comparing module (302) compares the current user input with the profile of the approved user (FIG. 1, 101). The location identifying module (303) identifies the location of the current user.

The patterns in the input and the location of the current user are used by the determining module (304) to determine the risk factor of the user. The re-authenticating module (305) then re-authenticates the user based on the risk factor. When a user passes re-authentication (314), the system repeats the process of comparing the user input with the profile of an approved user (FIG. 1, 101). When a current user fails re-authentication (315), the user account is disabled (310). Disabling the account may prevent an imposter user (FIG. 1, 102) from gaining access to the system.

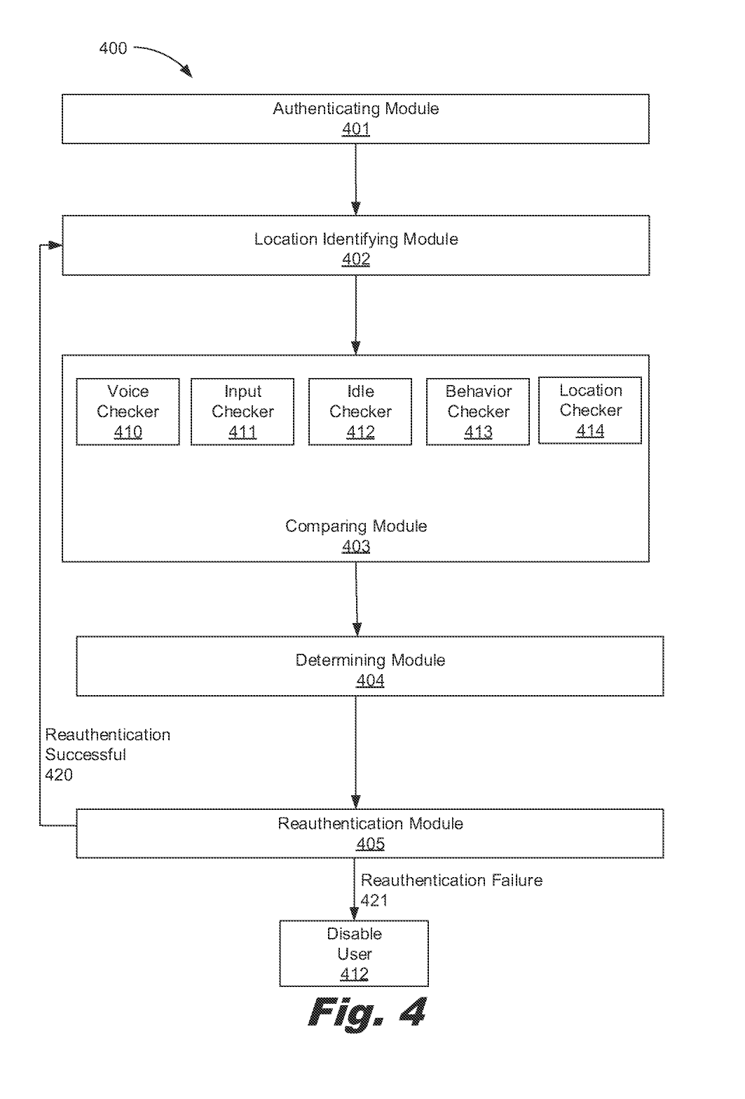

FIG. 4 illustrates an example of a system (400) for continuously authenticating a user of voice recognition services, according to the principles described herein. In this example, the system (400) includes the authenticating module (401), which initially authenticates a user by comparing vocal input to a pre-recorded file corresponding to an approved user.

The location identifying module (402) identifies a location of the current user. The location is determined by locating the device the current user is using. A user location may be determined using a global positioning system or through tracing the network protocol. A user that is determined to be in a secure and trusted location will have the risk factor adjusted to show reduced risk. A user that is determined to be in a public location, or a location the user does not frequent, will have the risk factor adjusted to show increased risk.

The comparing module (403) compares input from a current user to a user profile corresponding to the approved user. The comparing module (403) includes a voice checker (410), an input checker (411), an idle checker (412), a behavior checker (413), and a location checker (414). The voice checker (410) checks for traits associated with the voice sample. Traits include voice frequency, sound pronunciation, sound patterns, or similar identifiable traits of the voice sample. The input checker (411) checks other activity and behavior associated with the voice sample. The activity includes word usage, grammar usage, vocabulary usage, or similar activity. The input checker (411) may identify voice command patterns of the current user. The idle checker (412) increases the risk factor when a user has been idle for an amount of time set in the authentication parameters. For example, a user that has been idle for a number of hours will have the risk factor increased. A user who has continuously used the system (400) will not have the risk factor increased. The behavior checker (413) may check whether a set of commands issued by the user deviates from the commands customarily issued by an approved user. The deviation from the customary commands issued causes the behavior checker (413) to increase the risk factor. The behavior checker (413) also increases the risk factor when incorrect answers are provided according to the authentication criteria. The location checker (414) checks the location of the user against places where the user has been or may be during normal behavior.

The determining module (404) determines a risk factor that the current user is an imposter user (FIG. 1, 102). The determining module (404) uses data from the comparing module (403) to determine an amount of risk, based on the deviation from an approved user profile, that the current user is an imposter user (FIG. 1, 102).

The re-authenticating module (405) re-authenticates a user, based on the risk factor. The re-authenticating module (405) may use a number of authentication procedures to re-authenticate a user. A risk factor may indicate that there is little risk that the user is an imposter, in which case the user will be re-authenticated successfully (420) based on the voice sample. A user that has an increased risk factor may receive more questions as part of the re-authentication. The re-authentication module (405) may re-authenticate differently, depending on the location of the user. A user in a public location may be re-authenticated using nonverbal criteria. A user in a secure location may be re-authenticated with either verbal criteria, non-verbal criteria, or a mixture of criteria. A user for whom there is a successful re-authentication (420) will have any continued interaction sampled by the sampling module (401). A user for whom there is a failed re-authentication (421) may have the account deactivated, flagged, or other action taken to deal with the failed authentication. A user that fails re-authentication (421) is suspected by the system (400) of being an imposter user (FIG. 1, 102).

Aspects of the present system and method are described herein with reference to flowchart illustrations and/or block diagrams of methods, apparatus (systems) and computer program products, according to examples of the principles described herein. Each block of the flowchart illustrations and block diagrams, and combinations of blocks in the flowchart illustrations and block diagrams, may be implemented by computer usable program code. The computer usable program code may be provided to a processor of a general purpose computer, special purpose computer, or other programmable data processing apparatus to produce a machine, such that the computer usable program code, when executed via, for example, the processor (FIG. 2, 205) of the continuous voice authentication system (FIG. 2, 210) or other programmable data processing apparatus, implements the functions or acts specified in the flowchart and/or block diagram block or blocks.

The computer usable program code may be embodied within a computer readable storage medium; the computer readable storage medium being part of the computer program product. The computer readable storage medium may be a non-transitory computer readable medium.

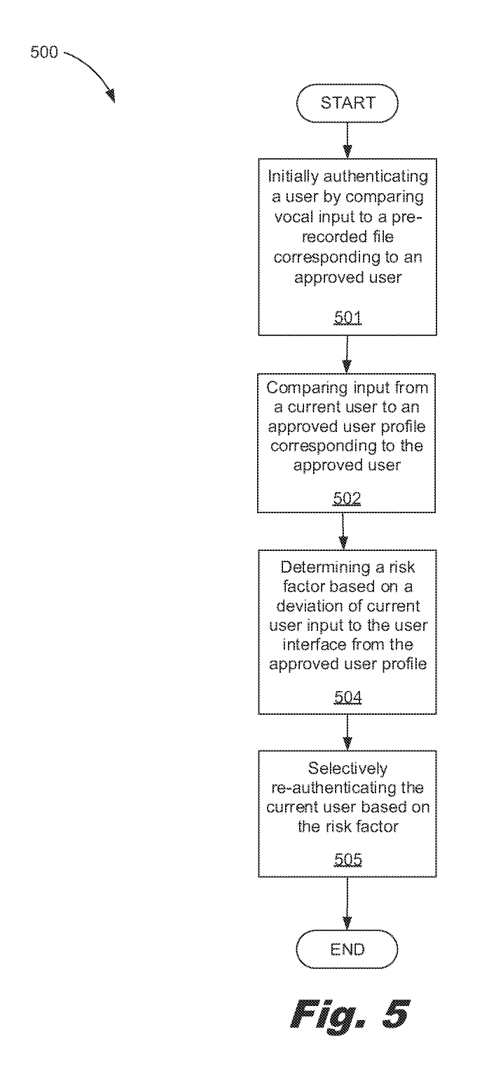

FIG. 5 is a flowchart of a method for continuous voice authentication, according to one example of the principles described herein. The method (500) may be executed by the voice authentication system of FIG. 1. The method (500) may be executed by other systems (i.e. system 200, system 700, system 800). As illustrated, the method (500) includes initially authenticating (block 501) a user by comparing vocal input to a pre-recorded file corresponding to an approved user. The method (500) includes comparing (block 502) input from a current user to an approved user (FIG. 1, 101) profile corresponding to the approved user (FIG. 1, 101). The method (500) includes determining (block 504) a risk factor based on a deviation of current user input to the user interface from the approved user profile. The method (500) includes selectively re-authenticating (block 505) the current user based on the risk factor.

As mentioned above. The method (500) includes initially authenticating (block 501) a user by comparing vocal input to a pre-recorded file corresponding to an approved user. The authenticating (block 501) may include additional authentication parameters, such as passwords, passcodes, or biometric data.

As mentioned above, the method (500) includes comparing (block 502) input from a current user to an approved user profile corresponding to the approved user (FIG. 1, 101). The input includes vocal input from an input device, such as a microphone.

As mentioned above, the method (500) includes comparing (block 502) input from a current user to an approved user (FIG. 1, 101) profile corresponding to the approved user (FIG. 1, 101). The comparing (block 502) compares vocal input from an input device to a profile associated with an approved user (FIG. 1, 201). The comparing (block 502) may compare non-verbal input from a user to a profile associated with an approved user (FIG. 1, 101). The comparing (block 502) may compare a vocal sample, a user vocal pattern, the user vocal pattern indicating vocal traits and behaviors of the current user with those associated with an approved user (FIG. 1, 101). The vocal traits may include voice frequency, sound pronunciation, word usage, grammar usage, vocabulary usage, and sound patterns. Comparing (block 502) may compare voice command patterns of the current user with voice command patterns previously performed by an approved user (FIG. 1, 201).

As mentioned above, the method (500) includes determining (block 504) a risk factor based on a deviation of current user input to the user interface from the approved user profile. The determining (block 504) determines a risk factor based on the comparing (block 502). The determining (block 504) may consider additional factors to determine the risk factor. The additional factors may include risk factors associated with the system, such as the security level of the systems or known attempts by unauthorized users to gain access to the system.

As mentioned above, the method (500) includes selectively re-authenticating (block 505) the current user based on the risk factor. The re-authenticating (508) may vary depending on the risk factor assigned to the user. The re-authenticating (508) may vary the amount of re-authentication the user is to pass prior to continuing to use the voice command system. A user that successfully passes re-authenticating (block 505) is likely an approved user (FIG. 1, 101). A user that fails re-authenticating (block 505) is likely an imposter user (FIG. 1, 102).

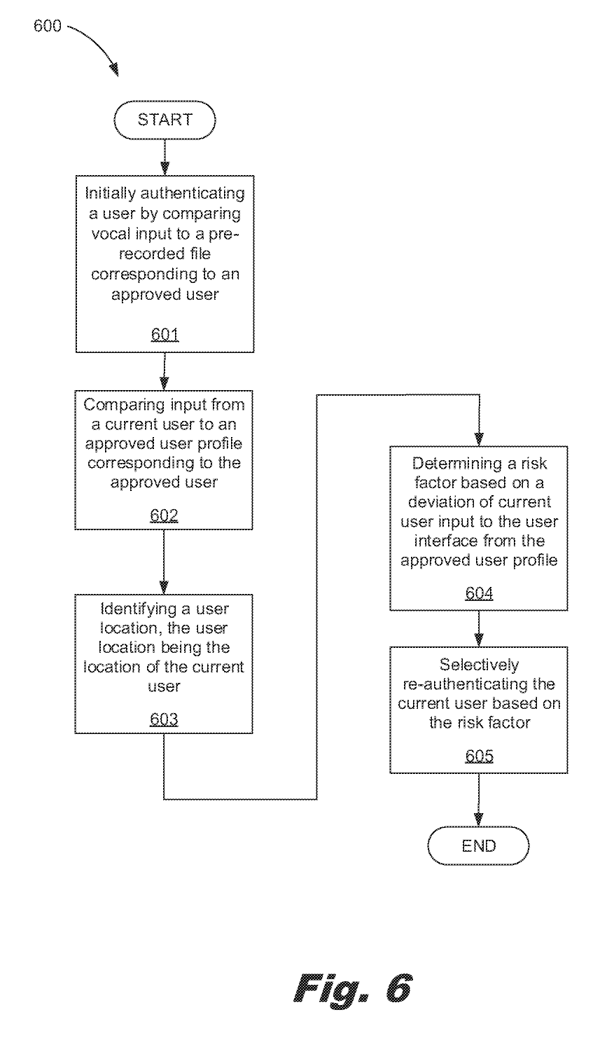

FIG. 6 is a flowchart of a method for continuous voice authentication, according to one example of the principles described herein. The method (600) may be executed by the voice authentication system of FIG. 1. The method (600) may be executed by other systems (i.e. system 200, system 700, system 800). As illustrated, the method (600) includes, with a user interface for a computer system that accepts vocal input. The method (600) includes initially authenticating (block 601) a user by comparing vocal input to a pre-recorded file corresponding to an approved user. The method (600) includes comparing (block 602) input from a current user to an approved user (FIG. 1, 101) profile corresponding to the approved user (FIG. 1, 101). The method (600) includes identifying (block 603) a user location, the user location being the location of the current user. The method (600) includes determining (block 604) a risk factor based on a deviation of current user input to the user interface from the approved user profile. The method (600) includes selectively re-authenticating (block 605) the current user based on the risk factor.

As mentioned above, the method (600) includes initially authenticating (block 601) a user by comparing vocal input to a pre-recorded file corresponding to an approved user. As mentioned above, the method (600) includes comparing (block 602) input from a current user to an approved user (FIG. 1, 101) profile corresponding to the approved user (FIG. 1, 101).

As mentioned above, the method (600) includes identifying (block 603) a user location, the user location being the location of the current user. In one example, a user location is identified through network tracing. In another example, a user location is identified through use of a global positioning system. Alternative methods of identifying the user location may be used.

As mentioned above, the method (600) includes comparing (block 602) input from a current user to an approved user (FIG. 1, 101) profile corresponding to the approved user (FIG. 1, 101). As mentioned above, the method (600) includes determining (block 604) a risk factor based on a deviation of current user input to the user interface from the approved user profile. A user that successfully passes re-authenticating (block 605) is likely an approved user (FIG. 1, 101). A user that fails re-authenticating (block 605) is likely an imposter user (FIG. 1, 102).

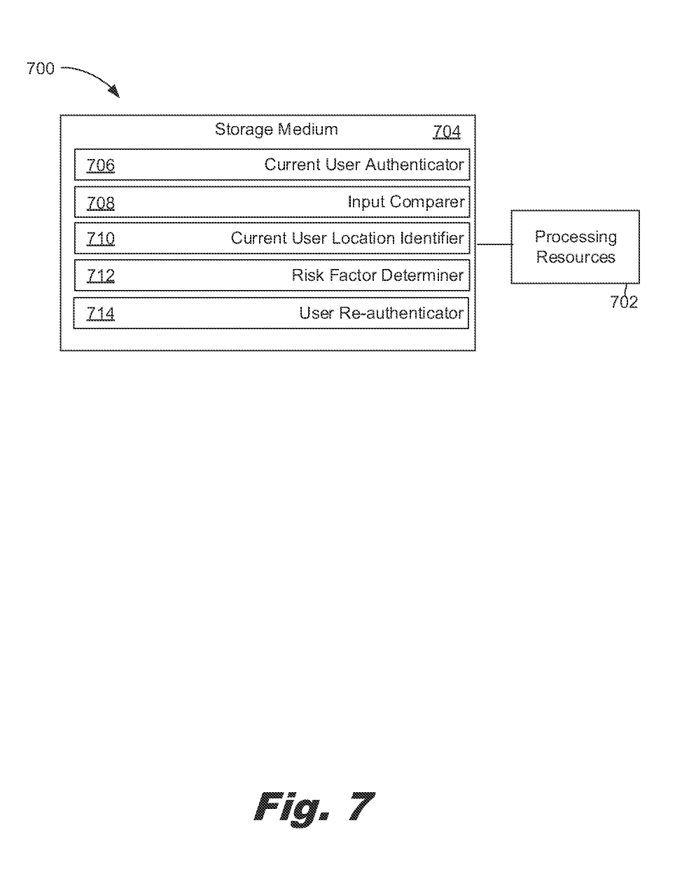

FIG. 7 is a diagram of a continuous voice authentication system (700) according to one example of the principles described herein. The continuous voice authentication system (700) includes processing resources (702) that are in communication with a storage medium (704). The processing resources (702) include at least one processor and other resources used to process programmed instructions. The storage medium (704) generally represents any memory capable of storing data, such as programmed instructions or data structures to be used by the continuous voice authentication system (700). The programmed instructions shown stored in the storage medium (704) include a current user authenticator (706), an input comparer (708), a current user location identifier (710), a risk factor determiner (712), and a user re-authenticator (714).

The user authenticator (706) represents programmed instructions that, when executed, cause the processing resource (702) to initially authenticate, with a user interface for a computer system that accepts vocal input, a user by comparing vocal input to a pre-recorded file corresponding to an approved user. The input comparer (708) represents programmed instructions that, when executed, cause the processing resource (702) to compare input from a current user to an approved user profile corresponding to the approved user.

The current user location identifier (710) represents programmed instructions that, when executed, cause the processing resource (702) to identify a user location, the location being the location of the current user. The risk factor determiner (712) represents programmed instructions that, when executed, cause the processing resource (702) to selectively re-authenticate the current user based on the risk factor. A user that successfully passes re-authenticating is likely an approved user (FIG. 1, 101). A user that fails re-authenticating is likely an imposter user (FIG. 1, 102).

The continuous voice authentication system (700) of FIG. 7 may be part of a general purpose computer. The continuous voice authentication system (700) of FIG. 7 may be part of a mobile device, such as a mobile telephone. However, in alternative examples, the continuous voice authentication system (700) is part of an application-specific circuit.

The flowchart and block diagrams in the Figures illustrate the architecture, functionality, and operations of possible implementations of systems, methods, and computer program products. In this regard, each block in the flowchart or block diagrams may represent a module, segment, or portion of code, which has a number of executable instructions for implementing the specific logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration and combination of blocks in the block diagrams and/or flowchart illustration, can be implemented by special purpose hardware-based systems that perform the specified functions or acts, or combinations of special purpose hardware and computer instructions.

The preceding description has been presented to illustrate and describe examples of the principles described. This description is not intended to be exhaustive or to limit these principles to any precise form disclosed. Many modifications and variations are possible in light of the above teaching.

1. A computer implemented method comprising:
with a user interface for a computer system that accepts vocal input, initially authenticating a user by comparing vocal input to a pre-recorded file corresponding to an approved user;
comparing input from a current user to an approved user profile corresponding to the approved user;
determining a risk factor based on a deviation of current user input to the user interface from the approved user profile; and
selectively re-authenticating the current user based on the risk factor, wherein an action required of the user to re-authenticate changes based on a level of the risk factor.

2. The method of claim 1, wherein the deviation of current user input from the approved user profile comprises deviation in both verbal and non-verbal behavior patterns.

3. The method of claim 1, wherein the approved user profile comprises vocal traits and behaviors of the current user in the set: voice frequency, sound pronunciation, word usage, grammar usage, vocabulary usage, intonation, breathing pattern, pause pattern, and sound patterns.

4. The method of claim 1, further comprising identifying a user location, the risk factor being increased or decreased depending on the user location.

5. The method of claim 1, wherein an action required for re-authentication includes entry of one of: a password, a passphrase, an answer to a number of challenge questions, a time-based token, a verbal phrase, biometric data, and combinations thereof.

6. The method of claim 1, wherein subsequently comparing current user input to the approved user profile occurs periodically.

7. The method of claim 1, wherein the re-authenticating the current user comprises different authentication measures based on the risk factor.

8. A system for continuously authenticating a user of voice recognition services, the system comprising:
a processor,
memory, communicatively connected to the processor,
an audio input, communicatively connected to the processor, and
a voice authentication system, the user voice authentication system comprising:
an authenticating module, to initially authenticate, using the audio input device, a user by comparing vocal input to a pre-recorded file corresponding to an approved user;
a comparing module, to compare input from a current user to an approved user profile corresponding to the approved user;
a location identifying module, to identify a user location, the user location being the location of the current user;
a determining module, to determine a risk factor based on a deviation of current user input to the user interface from the approved user profile; and
a re-authenticating module, to selectively re-authenticating the current user based on the risk factor.

9. The system of claim 8, wherein the approved user profile comprises both verbal and non-verbal behavior patterns of the approved user.

10. The system of claim 8, wherein the approved user profile comprises vocal traits and behaviors of the current user in the set: voice tone, accent, voice command usage pattern, voice frequency, sound pronunciation, word usage, grammar usage, vocabulary usage, intonation, breathing pattern, pause pattern, and sound patterns.

11. The system of claim 8, wherein the determining module determines the risk factor based on whether the user location is public or private.

12. The system of claim 8, wherein subsequently comparing current user input to the approved user profile occurs periodically.

13. The system of claim 8, wherein the re-authenticating the current user comprises different authentication measures based on the risk factor.

14. A computer program product comprising:
a non-transitory tangible computer readable storage medium, said tangible computer readable storage medium comprising computer readable program code embodied therewith, said computer readable program code comprising program instructions that, when executed, cause a processor to:
initially authenticate, with a user interface for a computer system that accepts vocal input, a user by comparing vocal input to a pre-recorded file corresponding to an approved user;
compare input from a current user to an approved user profile corresponding to the approved user;
determine a risk factor based on a deviation of current user input to the user interface from the approved user profile; and
selectively re-authenticate the current user based on the risk factor.

15. The product of claim 14, wherein the approved user profile comprises both verbal and non-verbal behavior patterns of the approved user.

16. The product of claim 14, wherein the risk factor is determined, in part, by how long user interface has been idle, the risk factor increasing with an increase in time the user interface has been idle.

17. The product of claim 14, further comprising selecting a different re-authentication measure based on whether a current user location is a public or private location.

18. The product of claim 14, further comprising adjusting the risk factor based on whether a current user location is a location where the approved user has operated previously.

19. The product of claim 14, wherein subsequently comparing current user input to the approved user profile occurs periodically.

20. The product of claim 14, wherein the re-authenticating the current user comprises a different number of authentication measures based on the risk factor, wherein more authentication measures are required for a higher risk factor.
